(19) United States
(12) Patent Application Publication
(10) Pub. No.: US 2009/0152759 A1
(43) Pub. Date: Jun. 18, 2009

(54) SHAPING DIE AND ITS USE IN A SOLID STATE DRAWING PROCESS

(76) Inventors: Bruce A. Malone, Midland, MI (US); Gregory T. Stewart, Midland, MI (US); Brett M. Birchmeier, Midland, MI (US); Timothy O. Kirch, Midland, MI (US)

Correspondence Address: The Dow Chemical Company, Intellectual Property Section, P.O. Box 1967, Midland, MI, 48641-1967, US

(21) Appl. No.: 12/327,122

(22) Filed: Dec. 3, 2008

Related U.S. Application Data
(60) Provisional application No. 61/014,127, filed on Dec. 17, 2007.

(51) Int. Cl. B29C 47/12

(52) U.S. Cl. 264/177.16; 425/467

(57) ABSTRACT

A solid state drawing die having a body with opposing entrance and exit ends, a shaping channel providing fluid communication entirely through the body from the entrance to exit end and having a converging profile, and at least one portion of the body that serves as a static protrusion extending into the but not all the way across the shaping channel is useful in a solid state drawing process for preparing oriented polymer compositions having indented or grooved profiles.

### CROSS REFERENCE STATEMENT

This application claims the benefit of U.S. Provisional Application No. 61/014,127 filed Dec. 17, 2007.

### BACKGROUND OF THE INVENTION

1. Field of the Invention

The present invention relates to a die suitable for use as a solid state drawing die and a process for solid state drawing a polymer composition.

2. Description of Related Art

It is desirable in the construction industry to have lumber with specific profile features. For example, the decking industry has developed hidden fasteners for attaching deck boards to a support structure without having exposed screws or nails. Hidden fasteners require a narrow groove feature along one or more side of the deck boards into which a fastener inserts. Similarly, flooring applications often benefit from tongue and groove features in opposing sides of a floor board so that the tongue of one board can insert into the groove of an adjoining board. Features such as the tongue and grooves are typically machined into wooden boards by milling out (removing) board material. Such milling requires removing and disposing of board material.

There is a growing interest in replacing wooden boards with polymer composite boards in numerous structural applications including decking. Early polymer composite boards merely comprise wood filler blended into a polymer matrix. Recent developments include oriented polymer composite (OPC) materials. OPC materials have improved modulus over non-oriented polymer composites of similar composition as a result of polymer alignment through a solid state drawing process. In a solid state drawing process, a polymer composition is drawn through a converging die while in a solid state in order to force alignment of polymer molecules. (See, for example, U.S. Pat. No. 4,938,913). Still more recent developments have included reducing density of OPC materials either through inclusion of a foaming agent (see, for example U.S. Pat. No. 5,474,722(A)) or through cavitation by drawing a filled polymer composition at a specific draw rate (see, for example, PCT publication WO 2004/009334 and United States published patent application 2005/0192382A1).

As with wooden boards, there is a desire for OPC materials to have profile features such as grooves. WO 01/45915 discloses an OPC article that has tongue and groove features on opposing sides. However, WO 01/45915 does not teach how to form the tongue and groove features on the OPC article. WO 01/45915 does mention that the OPC could be shaped and planed very much like wood, suggesting the tongue and groove features are likely milled into the OPC article after drawing. Milling and machining undesirably require a specific processing step and generate waste that requires disposal. It is desirable to introduce features into an OPC material while drawing it so as to avoid generation of waste.

U.S. Pat. No. 5,797,254 discloses a process for preparing a solid oriented polymer rod containing concave grooves. The process exemplified in U.S. Pat. No. 5,797,254 uses rollers, specifically spherical balls, to apply pressure onto a polymer rod within a solid state drawing die in order to introduce concave grooves while orienting the polymer rod. The rollers freely rotate within the drawing die during the drawing process. Hence, the die is a dynamic die having moving parts. In particular, the moving parts are those applying pressure against a polymer composition being drawn through the die. Such moving parts are desirable in a drawing die in order to minimize frictional forces on a polymer composition during the drawing process, advantages of which are well known and include reduction of drawing stress and reduction of shear flow deformation (see, for example U.S. Pat. No. 4,950,151 incorporated herein by reference in its entirety). These references leave unknown whether grooves can be introduced into a polymer within a drawing die when the drawing die is static (that is, free of moving parts). Static protrusions, as compared to dynamic protrusions, generate higher drawing stresses and there is a greater tendency to tear apart a polymer composition rather than merely deform it.

Molten polymer shaping processes are available that are capable of producing polymer articles having groove-like features using static protrusions in shaping dies. Molten shaping processes extrude a molten polymer through a shaping die containing static protrusions extending into the polymer flow path in order to introduce a groove into the polymer material. (See, for example, Extrusion Dies: Design and Engineering Computations, Walter Michaeli, Hanser Publishers, New York, 1984, pp. 234-255). Cooling the molten polymer once it has deformed around a static protrusion freezes in a groove feature introduced into the polymer material by the protrusion.

Unfortunately, molten polymers do not undergo orientation. As such, the resulting polymer material is not oriented and does not offer the strength or cavitation characteristics available in an OPC. Still more, a molten polymer can freely conform around a static protrusion so the concern over drawing stress is not applicable. A solid state material is much less malleable than a molten material and so is not generally expected to conform to static protrusions in a die but rather split or dissociate into multiple discrete pieces as the static protrusion divides or tears into the solid state material, if the static protrusion penetrates into the solid material at all. The likelihood of tearing away polymer composition increases as the cross sectional area of the static protrusion increases. Moreover, use of such shaping die is not typically a converging die and is therefore unsuitable for orienting a polymer composition.

### BRIEF SUMMARY OF THE INVENTION

The present invention provides a solid state drawing die and process for preparing an oriented polymer composition (OPC) that introduces a groove feature into solid state polymer material while orienting the solid state polymer material through a converging drawing die. Surprisingly, the process is able to introduce groove features into a solid state material using a static protrusion without dissociating (for example, tearing or fracturing) the solid material into multiple pieces. Even more surprising, the present invention is able to introduce groove features into a solid state material without dissociation of the solid state material while inducing orientation into the solid state material through solid state drawing.

It is remarkable that the static protrusion does not dissociate the polymer composition during the process of the present invention. While it is known in OPC art that a solid state material can undergo deformation in a converging drawing die, such known art forces deformation by directing polymer composition into itself (that is, forcing polymer composition to converge). In contrast, a static protrusion in the present invention imparts a dissociating force over a small area of the solid state polymer composition and forces the solid state polymer composition to part (that is, to diverge). This is similar to forcing a wedge of a log splitter into a log. Surprisingly, the solid state polymer composition parts around the static protrusion without fracturing, unlike a log when hit with the wedge of a log splitter. Surprisingly, a solid state polymer composition conforms to the static protrusion in the present die by being redirected in multiple directions around the static protrusion and yet, despite the diverging displacement, the polymer composition remains intact.

In a first aspect, the present invention is a solid state drawing die comprising: (i) a body having opposing entrance and exit ends; (ii) a shaping channel providing fluid communication entirely through the body from the entrance to exit end with the exposed body within the shaping channel serving as shaping channel walls wherein the shaping channel has a converging profile; and (iii) at least one portion of the body that serves as a static protrusion extending into but not all the way across the shaping channel.

Specific embodiments of the first aspect can include any one or combination of more than one of the following characteristics: the static protrusion extends into the shaping channel three millimeters or more and 50 millimeters or less as measured perpendicularly from a virtual shaping channel wall underneath the static protrusion; the static protrusion has a cross sectional area of five square millimeters or more and 1000 square millimeters or less; the static protrusion has an impact angle of 30° or more; static protrusion has a planar impact surface; the shaping channel contains multiple static protrusions that define a tongue feature in the shaping channel's cross section and in a polymer material drawn through the shaping channel; the shaping channel further comprises a static protrusion to create a groove in the shaping channel's cross section and in a polymer material drawn through the shaping channel; at least a portion of the static protrusion resides within a portion of the shaping channel within ten millimeters of the exit opening of the die; a portion of the shaping channel most proximate to the exit opening serves as a land section and at least a portion of the static protrusion resides within the land section; the static protrusion is preferentially heated with respect to the rest of the die body; and the static protrusion is removable from the rest of the die.

In a second aspect, the present invention is a process for solid state drawing of a polymer composition comprising the following steps: (a) providing a polymer composition having a softening temperature, Tₛ, and comprising a continuous orientable polymer; (b) conditioning the polymer composition to a drawing temperature, T_{d}, that is in a range between T_{c} and 50° C. below Tₛ, inclusive of endpoints; and (c) drawing the polymer composition through a solid state drawing die comprising: (i) a body having opposing entrance and exit ends; (ii) a shaping channel providing fluid communication entirely through the body from the entrance to exit end with the exposed body within the shaping channel serving as shaping channel walls wherein the shaping channel has a converging profile; and (iii) at least one portion of the body that serves as a static protrusion extending into but not all the way across the shaping channel; wherein the static protrusion of the drawing die forces displacement of the polymer composition around the static protrusion to create and indentation in the polymer composition without dissociating the polymer composition into two or more distinct pieces during step (c).

Specific embodiments of the second aspect can include any one or any combination of more than one of the following additional characteristics: the process further comprises inserting one or more calibrating probe into the indentation in the polymer composition as the polymer composition exits the drawing die and, desirably, retaining the calibrating probe in the indentation until the polymer composition ceases to draw down in cross sectional area; the static protrusion extends into the shaping channel three millimeters or more and 50 millimeter or less as measured perpendicularly from a virtual shaping channel wall underneath the static protrusion; the static protrusion extends into the shaping channel six millimeters or more and 50 millimeter or less as measured perpendicularly from a virtual shaping channel wall underneath the static protrusion; the static protrusion has an impact angle of 45° or more; the polymer composition simultaneously undergoes displacement around the static protrusion and experiences molecular orientation in the drawing direction; the static protrusion is preferentially heated with respect the rest of the solid state drawing die body; a portion of the shaping channel most proximate to the exit opening serves as a land section and at least a portion of the static protrusion resides within the land section; and the polymer composition has opposing sides and the die contains multiple static protrusions that define indentations in the polymer composition that serve as tongue and groove features on the opposing sides of the polymer composition.

### BRIEF DESCRIPTION OF DRAWINGS

FIG. 1. Illustrates a main converging portion of a die that, in combination with a land plate containing one or more static protrusion such as those in FIG. 2-6, forms a die of the present invention.

FIG. 2. Provides an illustration of a shaping land plate having opposing static protrusions each characterized by having a rectangular planar impact surface with a 27° impact angle.

FIG. 3. Provides an illustration of a shaping land plate having opposing static protrusions each characterized by having a triangular planar impact surface with a 27° impact angle.

FIG. 4. Provides an illustration of a shaping land plate having opposing static protrusions each characterized by having a rounded rectangular impact surface with a 37° impact angle.

FIG. 5. Provides an illustration of a shaping land plate having opposing static protrusions each characterized by having a rounded triangular impact surface with a 37° impact angle.

FIG. 6. Provides an illustration of a shaping land plate having opposing static protrusions each characterized by having a rectangular planar impact surface with a 90° impact angle.

### DETAILED DESCRIPTION OF THE INVENTION

### Terms

“Solid state” refers to a polymer (or polymer composition) that is below the softening temperature of the polymer (or polymer composition). Hence, “solid state drawing” refers to drawing a polymer or polymer composition that is at a temperature below the softening temperature of the polymer (or polymer composition).

“Polymer composition” comprises a continuous polymer phase containing at least one polymer component and can contain non-polymeric components.

“Softening temperature” (Tₛ) for a polymer or polymer composition having as polymer components only one or more than one semi-crystalline polymer is the melting temperature for the polymer composition.

“Melting temperature” (Tₘ) for a semi-crystalline polymer is the temperature half-way through a crystalline-to-melt phase change as determined by differential scanning calorimetry (DSC) upon heating a crystallized polymer at a specific heating rate. Determine Tₘ for a semi-crystalline polymer according to the DSC procedure in ASTM method E794-06. Determine Tₘ for a combination of polymers and for a filled polymer composition also by DSC under the same test conditions in ASTM method E794-06. If the combination of polymers or filled polymer composition only contains miscible polymers and only one crystalline-to-melt phase change is evident in its DSC curve, then Tₘ for the polymer combination or filled polymer composition is the temperature half-way through the phase change. If multiple crystalline-to-melt phase changes are evident in a DSC curve due to the presence of immiscible polymers, then Tₘ for the polymer combination or filled polymer composition is the Tₘ of the continuous phase polymer. If more than one polymer is continuous and they are not miscible, then the Tₘ for the polymer combination or filled polymer composition is the lowest Tₘ of the continuous phase polymers.

Tₛ for a polymer or polymer composition having as polymer components only one or more than one amorphous polymer is the glass transition temperature for the polymer composition.

“Glass transition temperature” (T_{g}) for a polymer or polymer composition is as determined by DSC according to the procedure in ASTM method E1356-03. Determine T_{g} for a combination of polymer and for a filled polymer composition also by DSC under the same test conditions in ASTM method E1356-03. If the combination of polymer or filled polymer composition only contains miscible polymers and only one glass transition phase change is evident in the DSC curve, then T_{g} of the polymer combination or filled polymer composition is the temperature half-way through the phase change. If multiple glass transition phase changes are evident in a DSC curve due to the presence of immiscible amorphous polymers, then T_{g} for the polymer combination or filled polymer composition is the T_{g} of the continuous phase polymer. If more than one amorphous polymer is continuous and they are not miscible, then the T_{g} for the polymer composition or filled polymer composition is the lowest T_{g} of the continuous phase polymers.

If the polymer composition contains a combination of semi-crystalline and amorphous polymers, the softening temperature of the polymer composition is the softening temperature of the continuous phase polymer or polymer composition. If the semi-crystalline and amorphous polymer phases are co-continuous, then the softening temperature of the combination is the lower softening temperature of the two phases.

“Drawing axis” is a line through a shaping channel of a drawing die that extends in the direction that the center of mass (centroid) of a polymer composition is moving as the polymer composition is drawn through the drawing die. Typically, and advantageously, the drawing axis lies on a substantially straight line or straight line extending through the shaping channel of a solid state drawing die.

“Centroid” refers to a point whose coordinates are the averages of the corresponding coordinates of a given set of points and which for a given plane (for example, a cross section) corresponds to the center of mass of a thin plate of uniform thickness and consistency or a body of uniform consistency having the same boundary.

“Centroid line” refers to a line containing the centroid for all cross sections of a die's shaping channel. For identifying the centroid line of a die, identify the centroid for a cross section of the shaping channel using virtual shaping channel walls in place of protrusions. Desirably, the centroid line of a solid state drawing die is a substantially straight line or a straight line. The centroid line lies on the drawing axis.

“Length of a shaping channel” is the distance from the entrance opening to the exit opening along the centroid line.

A “substantially straight line” may deviate from perfectly straight. For example, a “substantially straight line” means than any third point located between first and second points that are spaced at least one centimeter apart deviates from a perfectly straight line defined by the first and a second points by 10% or less, preferably 5% or less, more preferably 2% or less. Determine percent deviation by dividing the perpendicular distance of the third point from a line between the first two points by the distance between the first two points and then multiply by 100%. A substantially straight line may be perfectly straight.

“Cross sections” herein are perpendicular to the drawing axis unless the reference to the cross section indicates otherwise. A cross section has a centroid and a perimeter that defines a shape for the cross section.

A “cross sectional dimension” is the length of a straight line connecting two points on a cross section's perimeter and extending through the centroid of the cross section. For example, a cross sectional dimension of a rectilinear four-sided polymer composition could be the height or width of the polymer composition.

“Drawing temperature” is a temperature within a drawing temperature range at which a polymer is conditioned prior to drawing and is the temperature at which the polymer exists upon the initiation of drawing.

An artisan understands that a polymer composition typically has a variation in temperature through its cross section (that is, along a cross sectional dimension of the composition) during processing. Therefore, reference to temperature of a polymer composition refers to an average of the highest and lowest temperature along a cross sectional dimension of the polymer composition. The temperature at two different points along the polymer cross sectional dimension desirably differs by 10% or less, preferably 5% or less, more preferably 1% or less, most preferably by 0% from the average temperature of the highest and lowest temperature along the cross sectional dimension. Measure the temperature in degrees Celsius (° C.) along a cross sectional dimension by inserting thermocouples to different points along the cross sectional dimension.

“Converging profile” refers to a shaping channel that reduces in cross sectional area, preferably in a streamline fashion, over at least a portion of the shaping channel when proceeding from the entrance opening of the shaping channel to the exit opening of the shaping channel. In other words, a shaping channel has a converging profile if at least one cross section of the shaping channel has a cross sectional area greater than a cross section for the shaping channel more proximate to the exit opening of the shaping channel. Preferably, any cross section of the shaping channel in a converging die has a cross sectional area that is equal to or greater than the cross sectional area of any other cross section of the shaping channel more proximate to the exit opening of the shaping channel.

A “land section” of a shaping channel changes in cross sectional area by five percent or less, preferably two percent or less, more preferably has a uniform cross sectional area at any two points along the drawing axis through the land section.

“Streamlined flow” through a die refers to flow through a die that has been optimized to achieve maximum uniformity of flow and minimum flow resistance, in accordance with the definition in the Richmond reference. Notably, “flow” herein includes movement of polymer chains as they are deformed through a solid state drawing process and does not imply liquid state movement.

“Protrusion” refers to a feature that sticks out from its surroundings. In the present invention a protrusion is a portion of a die body that sticks out from surrounding portions of the die body and into the shaping channel of a drawing die. A protrusion forces and allows for diverging flow of polymer composition around it as the polymer composition travels through a shaping channel in the present die.

A “static protrusion” is a protrusion of a die that does not move with respect to the die while solid state drawing a polymer composition through the die.

“Virtual dimension” of a shaping channel is a cross sectional dimension whose magnitude is determined as though the shaping channel is free of protrusions. Measure the magnitude of a virtual dimension from a virtual shaping channel wall associated with any protrusion in the virtual dimension.

“Virtual shaping channel wall” is an imaginary line connecting two points on a shaping channel wall cross section on either side of a protrusion and that continues along a trajectory (path) of the shaping channel wall leading up to the protrusion. If the protrusion exists in a corner where two shaping channel walls would meet but for the protrusion, the virtual shaping channel wall is a combination of two imaginary lines continuing the shaping channel wall trajectory (path) of each shaping channel wall prior to the protrusion and meeting as if the protrusion did not exist.

“Impact angle” corresponds to an angle that a surface of a protrusion makes with the centroid line just prior to (more proximate to the entrance opening) the protrusion. It is also the angle the surface of the protrusion makes with the virtual shaping channel wall underneath the protrusion and extending parallel to the centroid line. The surface of the protrusion is that portion of the protrusion along the entire protrusion height that first contacts a polymer composition proceeding through a shaping channel containing the protrusion. Protrusion height is a dimension of the protrusion extending from the shaping channel wall to the centroid line of the die.

“Preferentially heated” means heat is directly applied apart from being directly applied elsewhere. For example, a protrusion is preferentially heated if more heat is applied directly into the protrusion than in areas proximate to the protrusion.

“Multiple” means at least two.

“ASTM” refers to an American Society for Testing and Materials test method. The year of the method is either designated by a hyphenated suffix in the method number or, in the absence of such a designation, is the most current year prior to the filing date of this application.

### Die

The die of the present invention is suitable for use as a solid state drawing die. The die is useful for orienting a polymer composition by drawing the polymer composition through the die. The die comprises a body having opposing ends and defining a shaping channel that provides fluid communication through the body from one end where the shaping channel is an entrance opening in the body to the opposing end where the shaping channel is an exit opening in the body. The portion of the body exposed within the shaping channel serves as shaping channel walls. The shaping channel walls converge (that is, reduce in cross sectional area) along at least a portion of the drawing axis proceeding from the entrance opening to the exit opening of the die's shaping channel. Hence, the die is a “converging” die and has a shaping channel with a converging profile. A desirable embodiment of the die includes a shaping channel having a land section that includes the exit opening. Desirably, dimensions of every cross section of the shaping channel all exceed 3 millimeters, preferably 5 millimeters. Dimensions extend from one side to another side of a cross section and go through the cross section's centroid.

At least one portion of the die body extends into the shaping channel in the form of a static protrusion. Desirably, the static protrusion extends along less than a full dimension of a shaping channel cross section. That is, a static protrusion desirably extends into a shaping channel without extending all the way across a shaping channel and extends from a portion of the shaping channel wall that is less than a full dimension of the shaping channel containing that portion of the channel wall. For example, a static protrusion in a shaping channel having a square or rectangular cross section desirably extends less than the width and less than the height of the shaping channel cross section. As another example, any dimension of a static protrusion in a shaping channel having a circular cross section desirably extends into the shaping channel less than the diameter of the shaping channel cross section.

The solid state drawing die can contain more than one static protrusion. There is no limit as to where multiple static protrusions may be with respect to one another. In one particularly desirable embodiment, the die comprises multiple static protrusions sufficient to define a tongue feature in the shaping channel cross section and in a polymer composition drawn through the shaping channel. In such an embodiment static protrusions are proximate to one another yet spaced apart by a distance correlating to the tongue feature's width. In yet another preferred embodiment the polymer composition has opposing sides and the drawing die has static protrusions oriented so as to introduce a tongue feature on one side of the polymer composition and a groove feature, desirably a mating groove feature, on the opposing side of the polymer composition. A mating groove feature fits into the tongue feature of another polymer composition drawn through the same solid state drawing die.

Static protrusions in the solid state die of the present invention can have any cross sectional shape conceivable including square, rectangular, triangular, arched, and complex shapes such as dovetail, keyhole and hooked.

The static protrusions extend into the shaping channel of the present die to a certain depth that is less than the distance to an opposing protrusion or shaping channel wall. In other words, the static protrusion extends into but not all the way across the shaping channel. Depth in this case is a virtual dimension and corresponds to a distance measured perpendicularly from a virtual shaping channel wall extending under the static protrusion.

Typically, a static protrusion will extend into the shaping channel a distance of three millimeters (mm) or more, preferably six mm or more and can extend to a distance of nine or ten mm or more into the shaping channel from a virtual shaping channel wall extending under the static protrusion. The static protrusion will extend less than all the way across the shaping channel (that is, the static protrusion will not divide a shaping channel cross section into two discrete openings). Typically, though not necessarily, a static protrusion will extend 50 mm or less into a shaping channel from a virtual shaping channel wall.

To effectively impart into a polymer composition an indentation that will remain in the polymer composition after it exits the die the static protrusion desirably extends the aforementioned distances into the shaping channel relative to the shaping channel wall at the exit opening of the shaping channel or, if the static protrusion exists at the exit opening, relative to a virtual shaping channel wall extending under the static protrusion at the exit opening of the shaping channel. As such, the indentation will have a depth into the polymer composition of three mm or more, preferably six mm or more and can be nine or ten mm or more and is typically 50 mm or less as the polymer composition exits the die.

The static protrusion has a cross sectional area defined in part by the virtual shaping channel wall under the static protrusion. The cross sectional area of the static protrusion can be five square millimeters (mm²) or more, 25 mm² or more, 50 mm² or more, 100 mm² or more 500 mm² or more. Typically, the cross sectional area of the static protrusion is 1000 mm² or less. One of the surprising results of the present invention is that the drawing die can displace a cross sectional area of 50 mm², even 1000 mm² in a solid state material being drawn through the solid state drawing die using a static protrusion without dissociating the polymer composition into discrete (herein, discrete takes on its standard meaning of separate and unconnected) pieces but rather by displacing the solid state material around the static protrusion and redistributing the material within the solid state polymer composition.

The static protrusion has an impact surface that is the portion of the static protrusion that a polymer composition first contacts along the static protrusion's height (dimension perpendicular to the virtual shaping channel wall beneath the static protrusion) as it travels through a shaping channel. The impact surface can be, for example, planar or linear (as in a knife edge). Typically, the angle the impact surface makes relative to a drawing axis prior (more proximate to the entrance opening) to the impact surface defines the impact angle.

The static protrusion can have any impact angle. Lower impact angles less aggressively displace polymer composition and therefore are less likely to tear apart the polymer composition. For that reason, lower impact angles are desirable. However, one of the surprising discoveries of the present invention is that static protrusions can have impact angles that exceed 30° and can be 45° or more, 60° or more, even 75° or more without dissociating a polymer composition drawn through a drawing die containing the static protrusion into two or more distinct pieces. In fact, the impact angle of a static protrusion can be up to and including 90° without dissociating a polymer composition drawn through a drawing die containing the static protrusion into two or more distinct pieces. A 90° impact angle corresponds to a static protrusion having an impact face extending perpendicular to the drawing axis and drawing direction of the polymer in the shaping channel.

The static protrusion can extend to essentially any length along the drawing axis in the shaping channel. However, it is desirable that at least a portion of the static protrusion reside within two centimeters, preferably within one centimeter, more preferably within five millimeters of the exit opening of the shaping channel. The static protrusion can extend all the way to the exit opening or even extend out of the exit opening of the shaping channel (thereby extending out of the die). In a preferred embodiment, the present die includes a land section containing the exit opening and a static protrusion within the land section.

The die can include heating and cooling elements. Suitable heating elements include cartridge heaters and channels through which heating and cooling media can flow. In one embodiment, the static protrusion is preferentially heated relative to the rest of the die. To preferentially heat a static protrusion, include a heating element in the static protrusion so as to apply heat to the static protrusion more directly than to the rest of the die. Preferentially heating the static protrusion allows a polymer composition forced against the static protrusion to undergo local softening and become more malleable, which facilitates the ability of the static protrusion to deform a polymer composition drawn through the die without dissociating the polymer composition into two or more distinct pieces. In one embodiment, preferentially heat the static protrusion to within a suitable drawing temperature range for the polymer composition so that polymer orientation can still occur. For example, heating a static protrusion with a cartridge heater and then thermally insulating the static protrusion from the rest of the die with an insulator (for example, ceramic material) allows heating of the static protrusion with minimal heating of the rest of the die. Heating a static protrusion to a temperature above a suitable drawing temperature range can, but does not necessarily, result in a reduction or loss of polymer orientation proximate to an indentation since the heating can enable an oriented polymer to relax and a non-oriented polymer to conform without orientation.

While the protrusions in the present die are static during a drawing process, the protrusions may be removable from the die itself to facilitate changing protrusion profiles. For example, static protrusions can be part of a removable piece that inserts into a die and is held in place with screws. Within such an example, changing or replacing a static protrusion merely involves unscrewing and removing one protrusion, inserting another and screwing it into place.

### Process

The process of the present invention is for solid state drawing of a polymer composition. The polymer composition contains one or more than one orientable polymer, which is a polymer that can undergo induced molecular orientation by solid state deformation (solid state drawing). An orientable polymer can be amorphous or semi-crystalline (semi-crystalline polymers have a melt temperature (Tₘ) and include those polymers known as “crystalline”). Desirable orientable polymers include semi-crystalline polymers, even more desirable are linear polymers (that is, polymers in which chain branching occurs in less than 1 of 1,000 polymer units). Semi-crystalline polymers are particularly desirable because they result in greater increase in strength and modulus than amorphous polymer compositions. Semi-crystalline polymer compositions can result in 4-10 times greater increase in strength and modulus upon orientation over amorphous polymer compositions.

Suitable orientable polymers include polymers and copolymers of polystyrene, polycarbonate, polypropylene, polyethylene (including high density polyethylene), polymethylpentane, polytetrafluoroethylene, polyamides, polyesters such as polyethylene terephthalate and polybutylene terephthalate, polycarbonates, polyethylene oxide, polyoxymethylene and blends thereof. Particularly desirably orientable polymers include polyethylene, polypropylene, and polyesters. More particularly desirable orientable polymers include linear polyethylene having a weight-average molecular weight from 50,000 to 3,000,000; especially from 100,000 to 1,500,000, even from 750,000 to 1,500,000. Polyvinylidene fluoride polymers having a weight-average molecular weight of from 200,000 to 800,000, preferably 250,000 to 400,000 are also suitable.

Polypropylene (PP)-based polymers are especially desirable for use in the present invention. PP-based polymers generally have a lower density than other orientable polymers. Therefore, PP-based polymers facilitate lighter articles than other orientable polymers. Additionally, PP-based polymers offer greater thermal stability than other orientable olefin polymers. Therefore, PP-based polymers may also form oriented articles having higher thermal stability than oriented articles of other polymers.

Suitable PP-based polymers include Zeigler Natta, metallocene and post-metallocene polypropylenes. Suitable PP-based polymers include PP homopolymer; PP random copolymer (with ethylene or other alpha-olefin present from 0.1 to 15 percent by weight of monomers); PP impact copolymers with either PP homopolymer or PP random copolymer matrix of 50-97 percent by weight (wt %) based on impact copolymer weight and with ethylene propylene copolymer rubber present at 3-50 wt % based on impact copolymer weight prepared in-reactor or an impact modifier or random copolymer rubber prepared by copolymerization of two or more alpha olefins prepared in-reactor; PP impact copolymer with either a PP homopolymer or PP random copolymer matrix for 50-97 wt % of the impact copolymer weight and with ethylene-propylene copolymer rubber present at 3-50 wt % of the impact copolymer weight added via compounding, or other rubber (impact modifier) prepared by copolymerization of two or more alpha olefins(such as ethylene-octene)by Zeigler-Natta, metallocene, or single-site catalysis, added via compounding such as but not limited to a twin screw extrusion process.

The PP-based polymer can be ultra-violet (UV) stabilized, and desirably can also be impact modified. Particularly desirable PP-based polymers are stabilized with organic stabilizers. A combination of low molecular weight and high molecular weight hindered amine-type light stabilizers (HALS) are desirable additives to impart UV stabilization to PP-based polymers. Suitable examples of commercially available stabilizers include IRGASTAB™ FS 811, IRGASTAB™ FS 812 (IRGASTAB is a trademark of Ciba Specialty Chemicals Corporation). A particularly desirable stabilizer system contains a combination of IRGASTAB™ FS 301, TINUVIN™ 123 and CHIMASSORB™ 119. (TINUVIN and CHIMASSORB are trademarks of Ciba Specialty chemicals Corporation).

The polymer composition may contain fillers including organic, inorganic or a combination of organic and inorganic. When the filler is a combination of organic and inorganic components it is desirable for the inorganic component to comprise 50 wt % or more, preferably 75 wt % or more of the filler.

Suitable organic fillers include cellulosic materials such as wood flour, wood pulp, flax and rice hulls. Suitable inorganic filler include mica, talc (including any or a combination of materials and grades commonly known and available as “talc”), chalk, titanium dioxide, clay, alumina, silica, glass beads, wollastonite, calcium carbonate, magnesium sulfate, barium sulfate, calcium oxysulfate, tin oxide, metal powder, glass powder, pigments, minerals, glass, ceramic, polymeric or carbon reinforcing agent fillers such as glass fibers, micas, talcs, carbon fibers, wollastonite, graphite, silica, magnesium carbonate, alumina, metal fibers, kaolin, silicon carbide, glass flake and the like. Fillers can serve many purposes include serving to enhance flame retardancy, induce cavitation during the drawing process, and provide partial reinforcement of an article.

The process requires thermally conditioning the polymer composition prior to drawing it through a solid state drawing die by bringing the polymer composition to a drawing temperature (T_{d}) within a drawing temperature range that is between the softening temperature (Tₛ) and 50° C. below Tₛ of the polymer composition and then initiating drawing of the polymer composition while the polymer composition remains within the drawing temperature range.

Desirably, condition a polymer composition to a drawing temperature of at least five degree Celsius (° C.), preferably at least ten ° C. below its Tₛ. The drawing temperature range can extend to twenty ° C. or more, even thirty ° C. or more below the polymer composition Tₛ. Orientation will not occur to any significant extent if the drawing temperature is above the orientable polymer composition's Tₛ. On the other hand, slow draw rates are necessary if the drawing temperature is too low due to a risk of fracturing the polymer composition during drawing. Generally, the drawing temperature is 40° C. or less below the polymer composition's Tₛ to avoid fracturing the polymer composition.

After conditioning the polymer composition to a drawing temperature, draw the polymer composition through the die of the present invention. In the present process, the die serves as a solid state drawing die. Desirably, the polymer composition has a smaller cross section shape (that is, cross sectional area) prior to drawing than the die entrance opening so that it fits into the shaping channel of the die.

Draw the polymer composition through the solid state drawing die by any means suitable for pulling a polymer composition through a solid state drawing die. For example, U.S. Pat. No. 5,797,254 describes suitable drawing method in column 3, lines 26-42 (incorporated herein by reference). In general, it is suitable to pull a polymer composition through a solid state drawing die by feeding the polymer composition through traction devices such as caterpillar drives. Two traction devices may be used and in a manner where the two traction devices are geared to one another to maintain a predetermined ratio of linear speed such that the second traction device operates faster than the first in order to elongate the polymer composition between the two devices.

It is particularly desirable to use a draw rate greater than 25.4 centimeters (10 inches) per minute, preferably greater than 127 centimeters (fifty inches) per minute, more preferably greater than 254 centimeters (100 inches) per minute. Faster draw rates provide more efficient production and the necessary stresses in the polymer composition to achieve a desired level of orientation. Faster draw rates can also facilitate cavitation, particularly around filler particles. An upper limit for the draw rate is unknown. Generally, the upper limit for draw rate is limited to that achievable with a reasonable drawing force. The drawing force should be less than the tensile strength of the polymer composition to avoid fracturing the polymer composition. Typically, the draw rate is 30.5 meters (1200 inches) per minute or less, more typically 9 meters (360 inches) per minute or less.

Upon drawing a polymer composition through the die of the present invention, the polymer composition both undergoes orientation and is shaped by at least one static protrusion so as to have at least one indentation or groove upon exiting the die. The polymer composition may also experience cavitation concomitant with orientation and being shaped or indented by a static protrusion.

It is surprising that the static protrusion does not dissociate the polymer composition. The static protrusion imparts a dissociating force over a small area of the solid state polymer composition and forces the solid state polymer composition to part. This is similar to forcing a wedge of a log splitter into a log. Surprisingly, the solid state polymer composition parts around the static protrusion without fracturing, unlike a log when thrust upon the wedge of a log splitter. The solid state polymer composition accommodates the static protrusion by displacing in multiple directions having components perpendicular to the drawing direction of the polymer through the shaping channel. Surprisingly, the solid state polymer composition undergoes such displacement while remaining in-tact.

Upon exiting the drawing die, it is beneficial to have one or more calibrating probe (calibrator) extend into an indentation or groove formed by a static protrusion in the drawing die, preferably until the polymer composition cools enough to be dimensionally stable. Calibrators can be rods, wheels, plates, or anything that will preserve the dimension of a groove in the polymer composition after the polymer composition exits the die. Without the calibrator in a groove or indentation, the polymer composition may deform as orientation stresses in the polymer composition relax and change the dimension of the groove or indentation.

The process of the present invention is useful for fabricating oriented polymeric articles having a shape embodying at least one groove or indentation.

The following examples serve to further illustrate embodiments of the present invention.

### EXAMPLES

Prepare an orientable polymer composition by feeding into a twin screw extruder (for example Maplan model TS-92): 50 weight-percent (wt %) INSPIRE™ 404 polypropylene (INSPIRE is a trademark of The Dow Chemical Company), 47.5 wt % TC-100 talc (available from Rio Tinto Corporation), and 2.5 wt % TR-251 lubricant (available from Struktol Corporation), with wt % based on total orientable polymer composition weight. The orientable polymer composition has a Tₛ of about 160° C. Extrude the polymer composition at a rate of 600 pounds per hour to form a rectangular billet that is 5.08 centimeters (two inches) high and 20.32 centimeters (eight inches) wide in cross sectional dimensions. Continuously feed the billet from the extruder through a water cooler, through a billet puller and conditioning ovens that bring the billet to a drawing temperature that is about 15° C. below Tₛ for the orientable polymer composition. Feed the billet at the drawing temperature directly into a converging die of the present invention, centering it into the opening of the die's shaping channel, draw it through the die and then cool it in a water spray (water temperature of about 27° C.) to form a shaped oriented polymer composition.

The converging drawing die for these examples comprise a main converging portion and a land portion that are separable from one another. That allows for changing the die by attaching different land sections to the main converging portion or by replacing the main converging portion with a new design. The land portion in each contains static protrusions which introduce grooves into a solid state polymer composition going through the die. Each example uses the same main converging portion, but utilizes a different land plate at the exit end of the die for the land portion. The different land plates have different static protrusions that introduce a groove or indentation into the orientable polymer composition (which at this point in the drawing process has at least begun to undergo orientation through the converging portion of the die) as it exits the die.

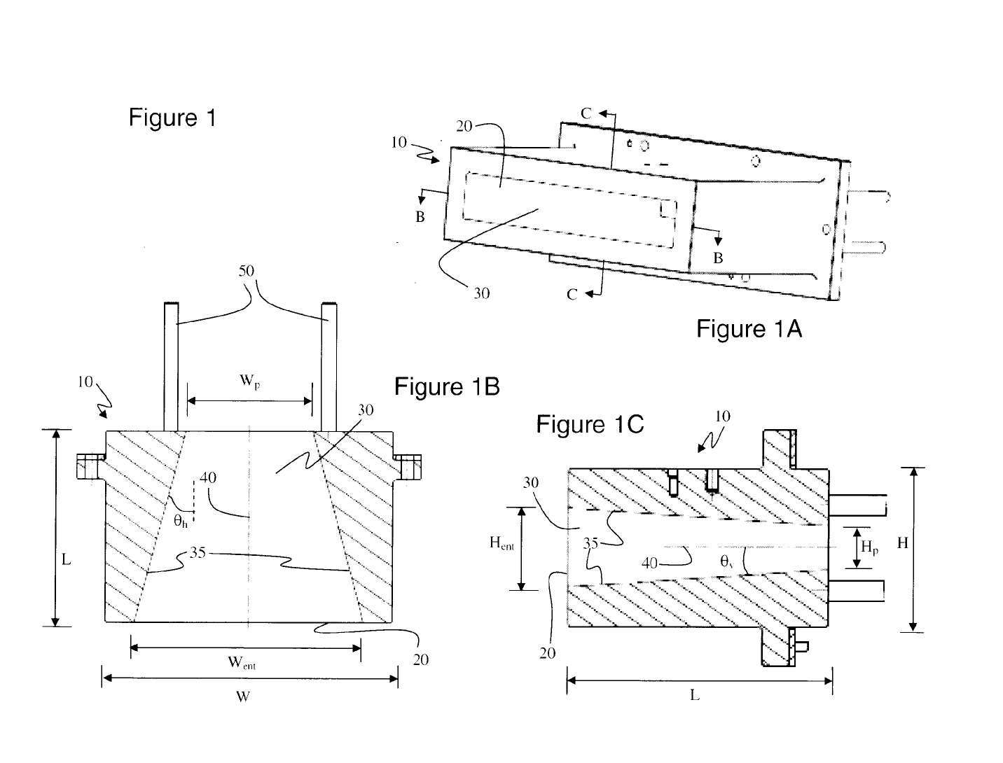

FIG. 1 illustrates the main converging portion 10 of the drawing die for use in the present examples. FIG. 1A illustrates an overview of the main converging portion 10 showing entrance opening 20 to shaping channel 30. FIG. 1B is a cut-away top view of main converging portion 10 as viewed along viewing lines B shown in FIG. 1A and illustrates entrance opening 20, shaping channel 30, shaping walls 35, centroid line 40, threaded mounting rods 50 and horizontal converging angle θₕ. Each shaping channel wall 35 converges towards centroid line 40 at horizontal converging angle θₕ of 15°. FIG. 1C is a cut-away side view of main converging portion 10 as viewed along viewing lines C shown in FIG. 1A and illustrates entrance opening 20, shaping channel 30, shaping walls 35, centroid line 40, threaded mounting rods 50 and vertical converging angle θᵥ. Each shaping channel wall 35 converges towards centroid line 40 at vertical converging angle θᵥ of 3.8°. Entrance opening 20 is rectangular and has a width (Wₑₙₜ) of 30.5 centimeters (12 inches) and a height (Hₑₙₜ) of 7.6 centimeters (3 inches). The opening over against which a land plate mounts is also rectangular and has a width (Wₚ) of 15.6 centimeters (6.125 inches) and a height (Hₚ) of 3.81 centimeters (1.5 inches) Main die portion 10 has a length (L) of 28 centimeters (11 inches), a width (W) of 46 centimeters (18 inches), and a height (H) of 23 centimeters (9 inches).

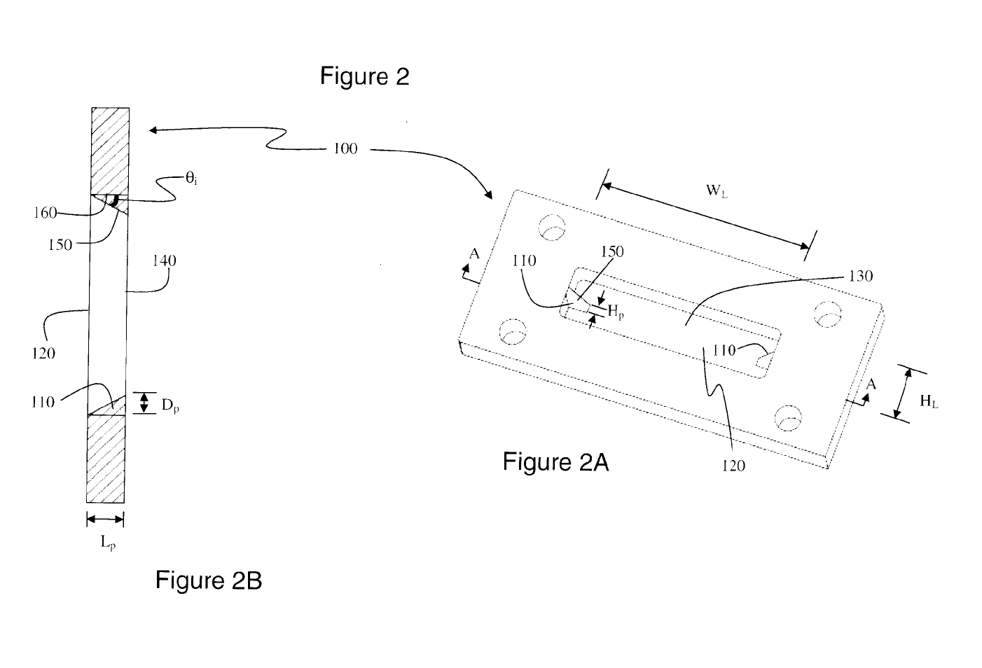

Threaded mounting rods 50 hold a land plate that mates up to main converging portion 10 of the die in order to form the complete converging die for use in the present examples. The land plates are illustrated in FIGS. 2-6. Mount the land plates by sliding them onto threaded rods 50 and then holding them flush to main converging portion 10 using nuts on each threaded rod 50.

### Example 1

### Rectangular Planar Protrusion Impact Surface at 27° Impact Angle

Prepare Example 1 using a die comprising main converging portion 10 from FIG. 1 with a land plate as illustrated in FIG. 2 attached as described above over mounting rods 50 illustrated in FIG. 1. FIG. 2 illustrates land plate 100 having static protrusions 110 extending into shaping channel 130 of land plate 100. FIG. 2A illustrates an overall view of land plate 100 viewing into entrance opening 120. FIG. 2B illustrates a top-view cut-away of the die plate as viewed along viewing line A illustrated in FIG. 2A. Exit opening 140 serves as the exit opening of the converging die when land plate 100 is attached to main converging portion 10.

Static protrusions 110 each have a rectangular planar impact surface 150 that forms impact angle θᵢ of 27° with virtual shaping channel wall 160 extending beneath each static protrusion 110. Each static protrusion extends into shaping channel 130 to a depth (Dₚ) of 1.27 centimeters (0.5 inches) and has a height (Hₚ) of 0.64 centimeters (0.25 inches) and length (Lₚ) of 2.54 centimeters (one inch). Shaping channel 130 has a width (W_{L}) of 15.6 centimeters (6.125 inches) and a height (H_{L}) of 3.81 centimeters (1.5 inches).

Draw the polymer composition through the converging die at a draw rate of about eight feet per minute. The static protrusions 110 introduce an indentation into the polymer composition that is apparent as the polymer composition exits the die. Use a single metal rod 0.32 centimeters (01.125 inches) in diameter as a calibrating probe. Position the metal rod approximately 50 centimeters (20 inches) from the exit opening of the die and such that it inserts to the full depth of the indentation.

The resulting oriented polymer composition has final dimension of 8.7 centimeters (3.4 inches) wide and 2.2 centimeters (0.87 inches) high. The polymer composition conforms to static protrusions 110 during the drawing process such that the resulting oriented polymer composition has grooves in opposing sides that extend into the oriented polymer composition to a depth of 0.28 centimeters (0.11 inches) with a height or width of 0.33 centimeters (0.13 inches). The resulting grooves are smooth and free of any visible protruding polymer composition fibers.

Static protrusions 110 introduce grooves into the solid state polymer composition in a solid state drawing die without dissociating any of the polymer composition into multiple distinct pieces.

### Example 2

### Triangular Planar Protrusion Impact Surface at 27° Impact Angle

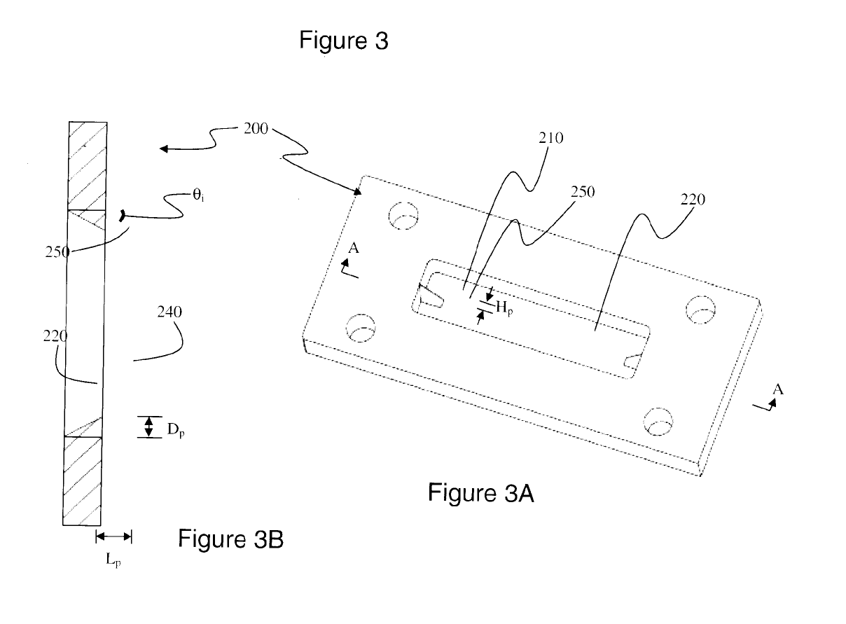

Prepare Example 2 using a die comprising main converging portion 10 from FIG. 1 with a land plate as illustrated in FIG. 3 attached as described for Example 1 over mounting rods 50 illustrated in FIG. 1. FIG. 3A illustrates an overall view of land plate 200 viewing into entrance opening 220. FIG. 3B illustrates a top-view cut-away of the die plate as viewed along viewing line A shown in FIG. 3A. Exit opening 240 serves as the exit opening of the converging die when land plate 200 is attached to main converging portion 10.

FIG. 3 illustrates land plate 200 that is identical to land plate 100 except in the shape of the static protrusion. Static protrusion 210 in land plate 200 has a triangular planar impact surface 250 that initially is a point and expands both in depth (Dₚ) of penetration into shaping channel and height (Hₚ). Dₚ and Hₚ are similar to that of land plate 100.

Draw the polymer composition through the converging die at a draw rate of about eight feet (2.4 meters) per minute. The static protrusions 210 introduce an indentation into the polymer composition that is apparent as the polymer composition exits the die. Use a series of four rolling disks to serve as calibrating probes within each indentation in the polymer composition. The rolling disks are 7.6 centimeters (three inches) in diameter and 0.59 centimeters (0.23 inches) thick. Position the rolling disks approximately 50 centimeters, 100 centimeters, 150 centimeters and 200 centimeters from the exit opening of the die and oriented such that the disk inserts into each indentation of the polymer composition and rolls along the bottom of the groove as the polymer is drawn by.

The resulting oriented polymer composition has final dimension of 9.7 centimeters (3.81 inches) wide and 2.4 centimeters (0.96 inches) high. The polymer composition conforms to static protrusions 210 during the drawing process such that the resulting oriented polymer composition has grooves in opposing sides that extend into the oriented polymer composition to a depth of 0.58 centimeters (0.23 inches) and a height or width of 0.3 centimeters (0.12 inches). The resulting grooves have a slightly rougher surface texture than Example 1 and any extending polymer fibers are tightly held in place and are short (less than two millimeters).

Static protrusions 210 introduce grooves into the solid state polymer composition in a solid state drawing die without dissociating any of the polymer composition into multiple distinct pieces.

### Example 3

### Rounded Rectangular Protrusion Surface at 37° Impact Angle

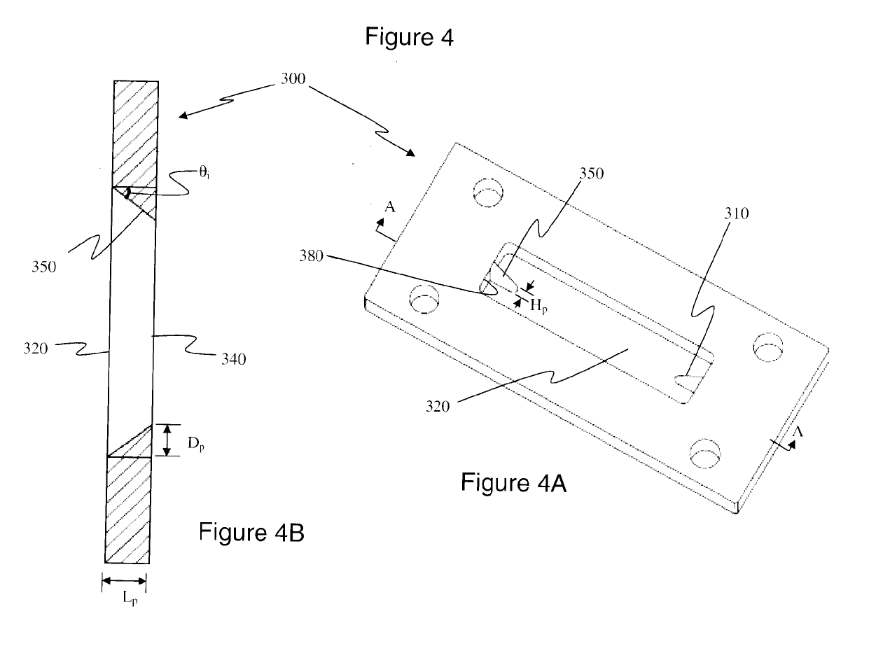

Prepare Example 3 using a die comprising main converging portion 10 from FIG. 1 with a land plate as illustrated in FIG. 4 attached as described for Example 1 over mounting rods 50 illustrated in FIG. 1. FIG. 4A illustrates an overall view of land plate 300 viewing into entrance opening 320. FIG. 4B illustrates a top-view cut-away of the die plate as viewed along viewing line A shown in FIG. 4A. Exit opening 340 serves as the exit opening of the converging die when land plate 300 is attached to main converging portion 10.

FIG. 4 illustrates land plate 300 that is similar to land plate 100 except: (1) the impact face 350 of static protrusions 310 have been rounded in gradual fashion such that there is minimal rounding proximate to shaping channel wall 380 and rounding reaches a 0.32 centimeters (0.125 inch) radius of curvature where static protrusion 310 is most remote from shaping channel wall 380; (2) impact angle θᵢ is 37°; and (3) the depth (Dₚ) of static protrusion 310 is 0.9 centimeters (0.75 inches).

Draw the polymer composition through the converging die at a draw rate of about eight feet (2.4 meters) per minute. The static protrusions 310 introduce an indentation into the polymer composition that is apparent as the polymer composition exits the die. Use a series of four rolling disks to serve as calibrating probes within each indentation in the polymer composition. The rolling disks are 7.6 centimeters (three inches) in diameter and 0.59 centimeters (0.23 inches) thick. Position the rolling disks approximately 50 centimeters, 100 centimeters, 150 centimeters and 200 centimeters from the exit opening of the die and oriented such that the disk inserts into each indentation of the polymer composition and rolls along the bottom of the groove as the polymer is drawn by.

The resulting oriented polymer composition has final dimension of 9.9 centimeters (3.91 inches) wide and 2.5 centimeters (0.98 inches) high. The polymer composition conforms to static protrusions 310 during the drawing process such that the resulting oriented polymer composition has grooves in opposing sides that extend into the oriented polymer composition to a depth of 0.76 centimeters (0.3 inches) and a height or width of 0.4 centimeters (0.16 inches). The resulting grooves have a slightly rougher surface texture than Example 1 and any extending polymer fibers are tightly held in place and are short (less than two millimeters).

Static protrusions 310 introduce grooves into the solid state polymer composition in a solid state drawing die without dissociating any of the polymer composition into multiple distinct pieces.

### Example 4

### Rounded Triangular Protrusion Surface at 37° Impact Angle

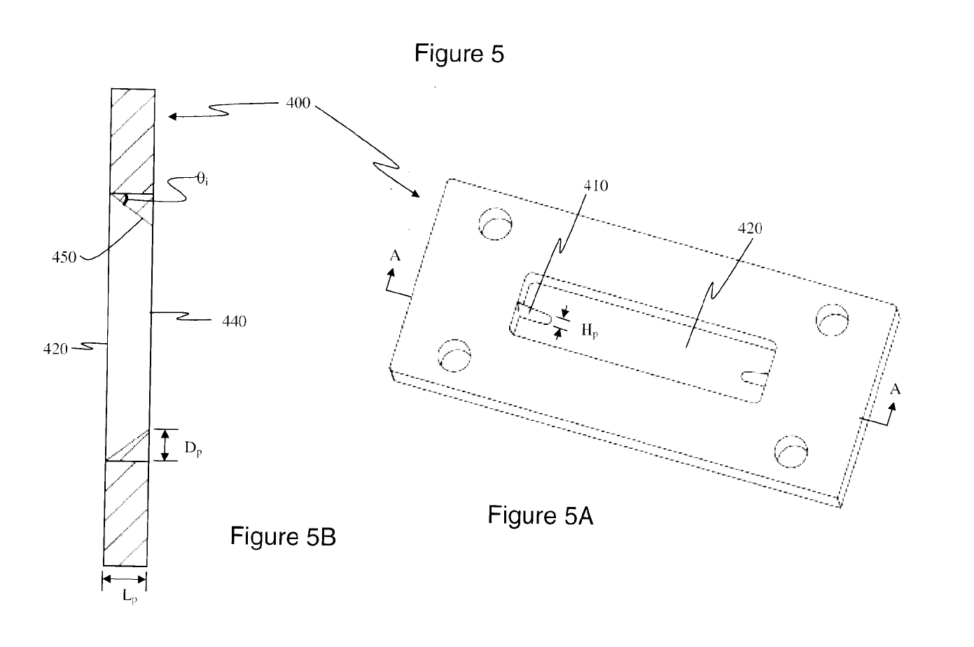

Prepare Example 4 using a die comprising main converging portion 10 from FIG. 1 with a land plate as illustrated in FIG. 5 attached as described for Example 1 over mounting rods 50 illustrated in FIG. 1. FIG. 5A illustrates an overall view of land plate 400 viewing into entrance opening 420. FIG. 5B illustrates a top-view cut-away of the die plate as viewed along viewing line A shown in FIG. 5A. Exit opening 440 serves as the exit opening of the converging die when land plate 400 is attached to main converging portion 10.

FIG. 5 illustrates land plate 400 that is identical to land plate 200 except: (1) the impact face 450 of static protrusions 410 have been rounded in gradual fashion such that there is minimal rounding proximate to shaping channel wall 480 and rounding reaches a 0.32 centimeters (0.125 inch) radius of curvature where static protrusion 410 is most remote from shaping channel wall 380; (2) impact angle θᵢ is 37°; and (3) the depth (Dₚ) of static protrusion 410 is 0.9 centimeters (0.75 inches).

Draw the polymer composition through the converging die at a draw rate of about eight feet (2.4 meters) per minute. The static protrusions 410 introduce an indentation into the polymer composition that is apparent as the polymer composition exits the die. Use a series of four rolling disks to serve as calibrating probes within each indentation in the polymer composition. The rolling disks are 7.6 centimeters (three inches) in diameter and 0.59 centimeters (0.23 inches) thick. Position the rolling disks approximately 50 centimeters, 100 centimeters, 150 centimeters and 200 centimeters from the exit opening of the die and oriented such that the disk inserts into each indentation of the polymer composition and rolls along the bottom of the groove as the polymer is drawn by.

The resulting oriented polymer composition has final dimension of 10.6 centimeters (4.16 inches) wide and 2.7 centimeters (1.07 inches) high. The polymer composition conforms to static protrusions 410 during the drawing process such that the resulting oriented polymer composition has grooves in opposing sides that extend into the oriented polymer composition to a depth of 1.09 centimeters (0.43 inches) and a height or width of 0.38 centimeters (0.15 inches). The resulting grooves have a slightly rougher surface texture than Example 1 and any extending polymer fibers are tightly held in place and are short (less than two millimeters).

Static protrusions 410 introduce grooves into the solid state polymer composition in a solid state drawing die without dissociating any of the polymer composition into multiple distinct pieces.

### Example 5

### Rectangular Planar Protrusion Impact Surface at 90° Impact Angle

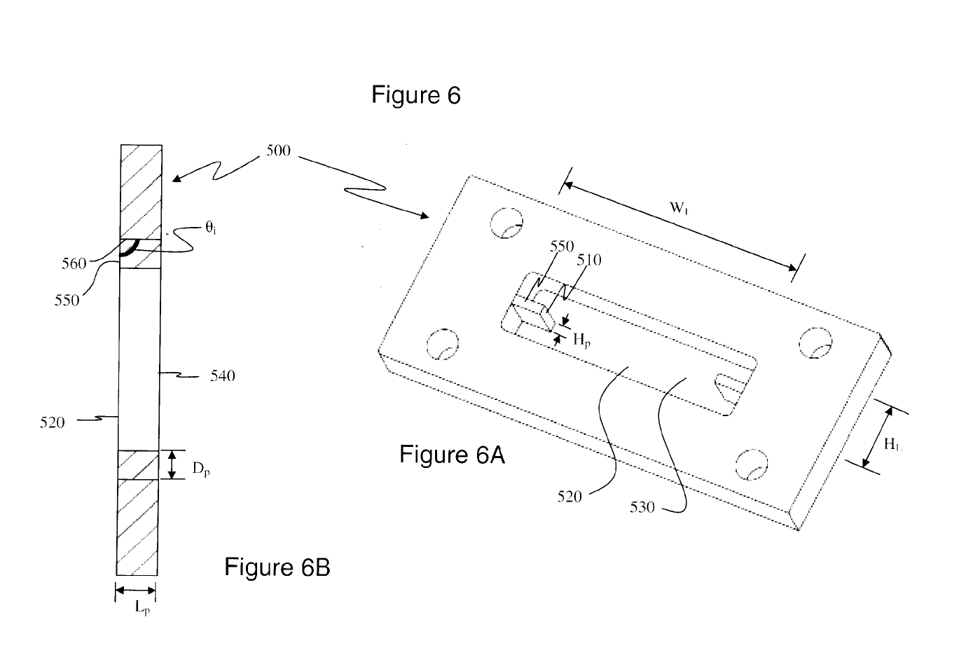

Prepare Example 5 using a die comprising main converging portion 10 from FIG. 1 with a land plate as illustrated in FIG. 6 attached as described above over mounting rods 50 illustrated in FIG. 1. FIG. 6 illustrates land plate 500 having static protrusions 510 extending into shaping channel 530 of land plate 500. FIG. 6A illustrates an overall view of land plate 500 viewing into entrance opening 520. FIG. 6B illustrates a top-view cut-away of the die plate as viewed along viewing line A illustrated in FIG. 6A. Exit opening 540 serves as the exit opening of the converging die when land plate 500 is attached to main converging portion 10.

Static protrusions 510 each have a rectangular planar impact surface 550 that forms impact angle θᵢ of 90° with virtual shaping channel wall 560 extending beneath each static protrusion 510. Each static protrusion extends into shaping channel 530 to a depth (Dₚ) of 1.9 centimeters (0.75 inches) and has a height (Hₚ) of 0.64 centimeters (0.25 inches) and length (Lₚ) of 2.54 centimeters (one inch). Shaping channel 530 has a width (W_{L}) of 15.6 centimeters (6.125 inches) and a height (H_{L}) of 3.81 centimeters (1.5 inches).

Draw the polymer composition through the converging die at a draw rate of about eight feet (2.4 meters) per minute. The static protrusions 510 introduce an indentation into the polymer composition that is apparent as the polymer composition exits the die. Use a series of four rolling disks to serve as calibrating probes within each indentation in the polymer composition. The rolling disks are 7.6 centimeters (three inches) in diameter and 0.59 centimeters (0.23 inches) thick. Position the rolling disks approximately 50 centimeters, 100 centimeters, 150 centimeters and 200 centimeters from the exit opening of the die and oriented such that the disk inserts into each indentation of the polymer composition and rolls along the bottom of the groove as the polymer is drawn by.

The resulting oriented polymer composition has final dimension of 9.0 centimeters (3.53 inches) wide and 2.1 centimeters (0.82 inches) high. The polymer composition conforms to static protrusions 510 during the drawing process such that the resulting oriented polymer composition has grooves in opposing sides that extend into the oriented polymer composition to a depth of 1.1 centimeters (0.42 inches) with a height or width of 0.38 centimeters (0.15 inches).

Static protrusions 510 introduce grooves into the solid state polymer composition in a solid state drawing die without dissociating any of the polymer composition into multiple distinct pieces.

### Example 6

### Tongue and Groove Die

Prepare Example 6 using a die comprising main converging portion 10 from FIG. 1 with a land plate similar to those of Examples 1-5. Centered on one side of the die is a static protrusion having a rounded triangular profile having an impact angle of 21°. The static protrusion extends to a depth of 0.97 centimeters (0.38 inches) into the shaping channel with a length of 2.54 centimeters (one inch) and a width of 0.94 centimeters (0.37 inches). On an opposing side of the land plate are two static protrusions having planar rectangular faces. Both static protrusions have an impact angle of 21°, one from the top shaping channel wall and one from the bottom shaping channel wall of the land plate. The static protrusions extend into the shaping channel 1.5 centimeters (0.58 inches) from the side shaping channel wall and 0.97 centimeters (0.38 inches) from the top or bottom shaping channel wall. There is a space between the static protrusions along the side of the shaping channel that defines a tongue shaping channel cross section.

Draw the polymer composition through the converging die at a draw rate of about eight feet (2.4 meters) per minute. Use a series of four rolling disks to serve as calibrating probes within the groove. The rolling disks are 7.6 centimeters (three inches) in diameter and 0.59 centimeters (0.23 inches) thick. Position the rolling disks approximately 50 centimeters, 100 centimeters, 150 centimeters and 200 centimeters from the exit opening of the die and oriented such that the disk inserts into the groove of the polymer composition and rolls along the bottom of the groove as the polymer is drawn by.

The resulting oriented polymer composition has final dimension of 8.7 centimeters (3.42 inches) wide and 2.5 centimeters (0.97 inches) high. The polymer composition conforms to static protrusions in the die plate during the drawing process such that the resulting oriented polymer composition has grooves defining a tongue on one side and a mating groove on an opposing side of the oriented polymer composition cross section. The resulting grooves have a slightly rougher surface texture than Example 1 and any extending polymer fibers are tightly held in place and are short (less than two millimeters).

The resulting grooves have a slightly rougher surface texture than Example 1 and any extending polymer fibers are tightly held in place and are short (less than two millimeters). The resulting grooves have a slightly rougher surface texture than Example 1 and any extending polymer fibers are tightly held in place and are short (less than two millimeters).

The static protrusion in the tongue and groove die introduce grooves into the solid state polymer composition in a solid state drawing die without dissociating any of the polymer composition into multiple distinct pieces.

What is claimed is:

1. A solid state drawing die comprising: (i) a body having opposing entrance and exit ends; (ii) a shaping channel providing fluid communication entirely through the body from the entrance to exit end with the exposed body within the shaping channel serving as shaping channel walls wherein the shaping channel has a converging profile; and (iii) at least one portion of the body that serves as a static protrusion extending into but not all the way across the shaping channel.

2. The solid state drawing die of claim 1, wherein the static protrusion extends into the shaping channel three millimeters or more and 50 millimeters or less as measured perpendicularly from a virtual shaping channel wall underneath the static protrusion.

3. The solid state drawing die of claim 1, wherein the static protrusion has a cross sectional area of five square millimeters or more and 1000 square millimeters or less.

4. The solid state drawing die of claim 1, wherein the static protrusion has an impact angle of 30° or more.

5. The solid state drawing die of claim 1, wherein the static protrusion has a planar impact surface.

6. The drawing die of claim 1, wherein the shaping channel contains multiple static protrusions that define a tongue feature in the shaping channel's cross section and in a polymer material drawn through the shaping channel.

7. The drawing die of claim 6, wherein the shaping channel further comprises a static protrusion to create a groove in the shaping channel's cross section and in a polymer material drawn through the shaping channel.

8. The drawing die of claim 1, wherein at least a portion of the static protrusion resides within a portion of the shaping channel within ten millimeters of the exit opening of the die.

9. The drawing die of claim 8, wherein a portion of the shaping channel most proximate to the exit opening serves as a land section and at least a portion of the static protrusion resides within the land section.

10. The drawing die of claim 1, wherein the static protrusion is preferentially heated with respect to the rest of the die body.

11. A process for solid state drawing of a polymer composition comprising the following steps:
a. providing a polymer composition having a softening temperature, Tₛ, and comprising a continuous orientable polymer;
b. conditioning the polymer composition to a drawing temperature, T_{d}, that is in a range between Tₛ and 50° C. below Tₛ, inclusive of endpoints; and
c. drawing the polymer composition through a solid state drawing die comprising: (i) a body having opposing entrance and exit ends; (ii) a shaping channel providing fluid communication entirely through the body from the entrance to exit end with the exposed body within the shaping channel serving as shaping channel walls wherein the shaping channel has a converging profile; and (iii) at least one portion of the body that serves as a static protrusion extending into but not all the way across the shaping channel;
wherein the static protrusion of the drawing die forces displacement of the polymer composition around the static protrusion to create and indentation in the polymer composition without dissociating the polymer composition into two or more distinct pieces during step (c).

12. The process of claim 11, further comprising inserting one or more calibrating probe into the indentation in the polymer composition as the polymer composition exits the drawing die.

13. The process of claim 12, further comprising retaining the calibrating probe in the indentation until the polymer composition ceases to draw down in cross sectional area.

14. The process of claim 11, wherein the static protrusion extends into the shaping channel three millimeters or more and 50 millimeter or less as measured perpendicularly from a virtual shaping channel wall underneath the static protrusion.

15. The process of claim 11, wherein the static protrusion extends into the shaping channel six millimeters or more and 50 millimeter or less as measured perpendicularly from a virtual shaping channel wall underneath the static protrusion.

16. The process of claim 11, wherein the static protrusion has an impact angle of 45° or more.

17. The process of claim 11, wherein the polymer composition simultaneously undergoes displacement around the static protrusion and experiences molecular orientation in the drawing direction.

18. The process of claim 11, wherein the static protrusion is preferentially heated with respect the rest of the solid state drawing die body.

19. The process of claim 11, wherein a portion of the shaping channel most proximate to the exit opening serves as a land section and at least a portion of the static protrusion resides within the land section.

20. The process of claim 11, wherein the polymer composition has opposing sides and the die contains multiple static protrusions that define indentations in the polymer composition that serve as tongue and groove features on the opposing sides of the polymer composition.
